(19) United States
(12) Patent Application Publication
(10) Pub. No.: US 2007/0166071 A1
(43) Pub. Date: Jul. 19, 2007

(54) BELT MEMBER DRIVING MECHANISM, BELT MEMBER DRIVING METHOD AND IMAGE FORMING APPARATUS

(76) Inventor: Yasuo Shima, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/467,790

(22) Filed: Aug. 28, 2006

(30) Foreign Application Priority Data
Jan. 18, 2006 (JP) 2006-010044

(51) Int. Cl. G03G 21/20; G03G 15/01

(52) U.S. Cl. 399/94; 399/303

(57) ABSTRACT

A belt member driving mechanism includes a first roller having a rotation shaft and configured to be rotated in a first direction, a belt member including a belt surface having a predetermined width in a second direction orthogonal to the first direction and configured to be rotated by a driving force from the first roller, a second roller configured to apply a predetermined tension force to the belt member in cooperation with the first roller, and a temperature control unit, including a detection unit which detects an elongation and/or a contraction of the belt surface of the belt member, configured to produce a temperature difference along the second direction of the belt surface of the belt member to reduce the elongation or contraction.

### CROSS-REFERENCE TO RELATED APPLICATIONS

This application is based upon and claims the benefit of priority from prior Japanese Patent Application No. 2006-010044, filed Jan. 18, 2006, the entire contents of which are incorporated herein by reference.

### BACKGROUND OF THE INVENTION

1. Field of the Invention

The present invention relates to an image forming apparatus having, for example, a plurality of individual color image forming units arranged in a conveying direction of an image forming medium (sheet) to form a color image with their own individual colors registered and an oblique movement correction mechanism for an endless belt member in the image forming apparatus.

2. Description of the Related Art

Various methods are known which form a color image on an image forming medium, such as a sheet-like material and a transparent resin sheet. For example, there are known an electrophotographic system for forming an electrostatic latent image as an electrostatic image on a photosensitive drum and transferring a visible toner image on an image forming medium, an ink jet system for jetting an ink droplet directly on the image forming medium and forming an image, a silver halide photographing system (?) for exposing a photosensitive color developing material to light to record a corresponding image, etc.

In the image forming apparatus using the electrophotographic system, a toner image of corresponding one of three primary colors (yellow, magenta, cyan) for forming a color image on a photosensitive drum is transferred to an image forming medium (hereinafter referred to as a sheet), that is, such a transfer step for respective colors is repeated three times (or four times in the case of including a black color). In addition to this system, for example, image forming units for forming individual color toner images are arranged in a sheet conveying direction in a way to correspond to black and primary colors and those image of corresponding colors are sequentially formed on the sheet to provide a color image with their colors registered.

In these systems, a tandem system here called as such has a plurality of image forming units arranged in the sheet conveying direction and is excellent over other systems in terms of an image forming (print recording) speed and constitutes one of optimal systems to achieve a compact unit. It is to be noted that, in the tandem system, an endless belt is usually used for conveying a sheet. In the case of using an endless belt, it is known that the belt is run (moved) obliquely.

In JP-A 2005-148675(KOKAI), in order to prevent the oblique movement of a transfer belt (endless belt), a rib is provided to allow the shoulder portion of a roller to be set in contact with the rib and, by doing so, to restrict the oblique movement.

Even in this method, the rib is not accurately set to the belt and there sometimes occurs the winding movement of the belt.

Further, it is also known that, due to a stress concentration generated upon impact between the shoulder of the roller and the rib of the belt, wrinkles occur on the belt to cause an image to be displaced in a main scanning direction and, in the worst case, the belt to be injured.

In other methods not disclosed in the Publication above, a proposal is made to adopt a method of directly applying pressure to a belt from an outside, a method of varying a parallel extent of a rotation shaft of a belt by a fine-motion adjusting mechanism mounted on that shaft, and so on. In either case, belt service life is lowered due to a direct force applied to a transfer belt or a drive system involved becomes complicated.

### BRIEF SUMMARY OF THE INVENTION

In an aspect of the present invention, there is provided a belt member driving mechanism comprising:

a first roller having a rotation shaft and configured to be rotated in a first direction;

a belt member including a belt surface having a predetermined width in a second direction orthogonal to the first direction and configured to be rotated by a driving force from the first roller;

a second roller configured to apply a predetermined tension force to the belt member in cooperation with the first roller; and

a temperature control unit, including a detection unit which detects an elongation and/or a contraction of the belt surface of the belt member, configured to produce a temperature difference along the second direction of the belt surface of the belt member to reduce the elongation or contraction.

### BRIEF DESCRIPTION OF THE SEVERAL VIEWS OF THE DRAWING

FIG. 1 is a diagrammatic view showing one form of an image forming apparatus having a transfer belt member applicable thereto;

FIG. 2 is a diagrammatic view for explaining one form of an oblique movement correction mechanism of the transfer (endless) belt member incorporated into the image forming apparatus shown in FIG. 1;

FIGS. 3A to 3C, each, are a diagrammatic view for explaining the movement of the belt member (the driving by a rotation shaft and oblique movement) shown in FIG. 2;

FIG. 4 is a diagrammatic view for explaining one form of a heating unit of a belt oblique movement correction mechanism shown in FIG. 2;

FIG. 5 is a diagrammatic view for explaining one form of a cooling unit of a belt oblique movement correction mechanism shown in FIG. 2;

FIG. 6 is a diagrammatic block diagram for explaining one form of an oblique movement correction mechanism control section for controlling the belt oblique movement mechanism shown in FIG. 2; and

FIG. 7 is a diagrammatic view for explaining another embodiment of a belt oblique movement correction mechanism (oblique movement correction mechanism incorporated into a rotation shaft as one unit) shown in FIG. 1.

### DETAILED DESCRIPTION OF THE INVENTION

An embodiment of the present invention will be described below with reference to the drawing.

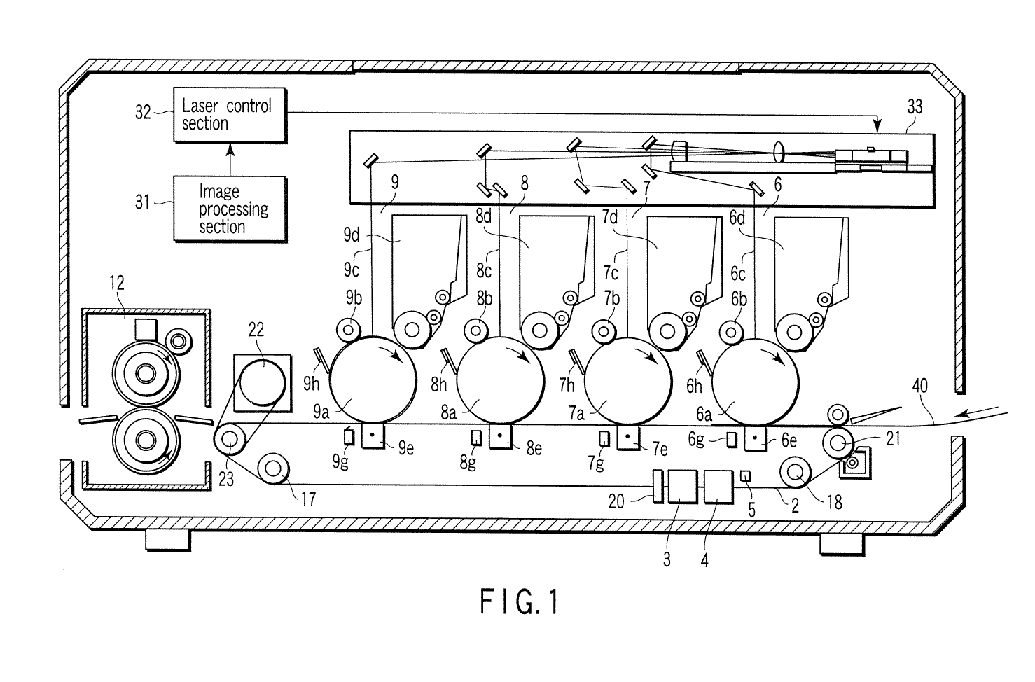

FIG. 1 shows one example of a tandem system color image forming apparatus for forming a color image using, as an image carrying member, an endless belt member to which is applied a belt oblique movement correction mechanism of the present invention.

The color image forming apparatus 1 as shown in FIG. 1 has an endless belt member (hereinafter referred to as a transfer belt member) 2 for conveying a sheet-like image forming medium (40) having a toner image formed by a corresponding color image forming unit as will be set out in more detail below.

A heating unit 3 for selectively heating an arbitrary position of the belt member 2 and a cooling unit 4 for selectively cooling an arbitrary position of the belt member 2 are located at these positions of a rotary running belt area where a temperature variation is applied to the belt member. It is to be noted that the heating unit 3 and cooling unit 4 are located in a non-contacting relation to an arbitrary surface of the belt member 2.

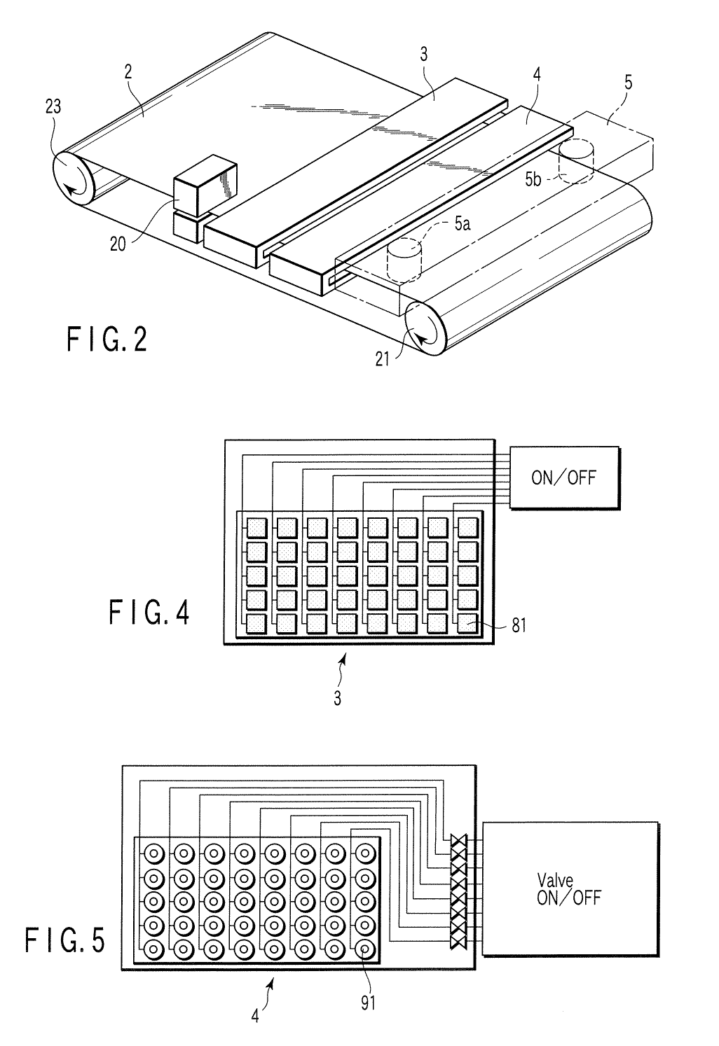

As shown extracted from FIG. 2, a temperature sensing unit 5 for detecting a temperature of the belt member 2 is provided at a belt temperature detectable position near to the heating unit 3 or cooling unit 4 and a belt edge position sensing unit 20 is provided at that predetermined position of the belt rotary running (moving) area where the edge of the belt member is passed.

At that predetermined conveying range of the belt rotary running area where a sheet-like image forming medium (hereinafter referred to as a sheet), is conveyed, first, second, third and fourth image forming units 6, 7, 8 and 9, forming four color images, respectively, of yellow (Y image), magenta (M image), cyan (C image) and black (Bk image) are arranged in a sheet 40 conveying direction, that is, along a belt surface running (moving) direction, in a relation spaced a predetermined distance apart from the transfer belt member 2.

The image forming units have photosensitive drums 6a, 7a, 8a, and 9a, that is, image recording media with electrostatic latent images as electrostatic images, charging rollers 6b, 7b, 8b, and 9b uniformly charging the corresponding photosensitive drum surfaces, developing units 6d, 7d, 8d, and 9d allowing corresponding toners to be supplied to the corresponding electrostatic latent images on the surfaces of the corresponding drums and these toners to be developed under exposure light 6c, 7c, 8c, and 9c, that is, light beams corresponding to image information items, to form toner images, transfer units 6e, 7e, 8e, and 9e allowing the toner images on the photosensitive drums to be transferred to the sheet 40 held by the transfer belt member 2, discharging lamps 6g, 7g, 8g, and 9g allowing the discharging to be effected on the drum surfaces after the transfer has been made, and cleaning blades 6h, 7h, 8h and 9h.

It is to be noted that the respective exposure beams 6c, 7c, 8c, and 9c have their intensities varied according to laser drive signals supplied from a laser control section 32 to a light exposure unit 33 so as to correspond to the image information items of the four color images coming from an image processing section 31 and then are emitted as laser beams from the light exposure unit.

The transfer belt member 2 has its own surface run at a predetermined speed, for example, under both a tension roller 21 provided near to a sheet supply section on the sheet 40 supply side and a drive roller 23 rotated by a motor 22.

A predetermined tension is applied to the sheet 40 under a plurality of (two in the present embodiment) guide rollers 17 and 18, without producing any slack state, to allow the belt surface to be run along the respective image forming units, while assuring a generally flattened surface under such belt driving.

The four color toner images formed by the corresponding image forming units, that is, the Y image, M image, C image and Bk image are developed by the developing units 6d, 7d, 8d, and 9d held with corresponding color toners to provide corresponding color toner images on the sheet 40. These respective color toner images are transferred, while being sequentially registered, under the electrostatic forces from the transfer units 6e, 7e, 8e, and 9e to the sheet 40.

The sheet 40 with the toner images thus transferred is guided to a fixing unit 12, while allowing the belt surface of the transfer belt member to be run, where a toner image is fixed under the application of heat and pressure of the fixing unit 12. Then the image-fixed sheet is delivered to an outside of the image forming apparatus 1. That is, a color image is formed on the sheet 40 by the above-mentioned sequential image forming steps.

It is known that, when the belt surface is moved by the rotation of the drive roller 23, it will be moved, in the long run, toward the axial direction of the drive roller 23. The movement of the belt member 2 toward such an axial direction of the drive roller 23 is called an oblique or winding movement.

In order to avoid the oblique or winding movement of the transfer belt member, either an external force is applied to the belt member itself or the axial variation of the tension roller is effected. These are practically done, but some problems remain unsolvable such as the wrinkling of the belt member.

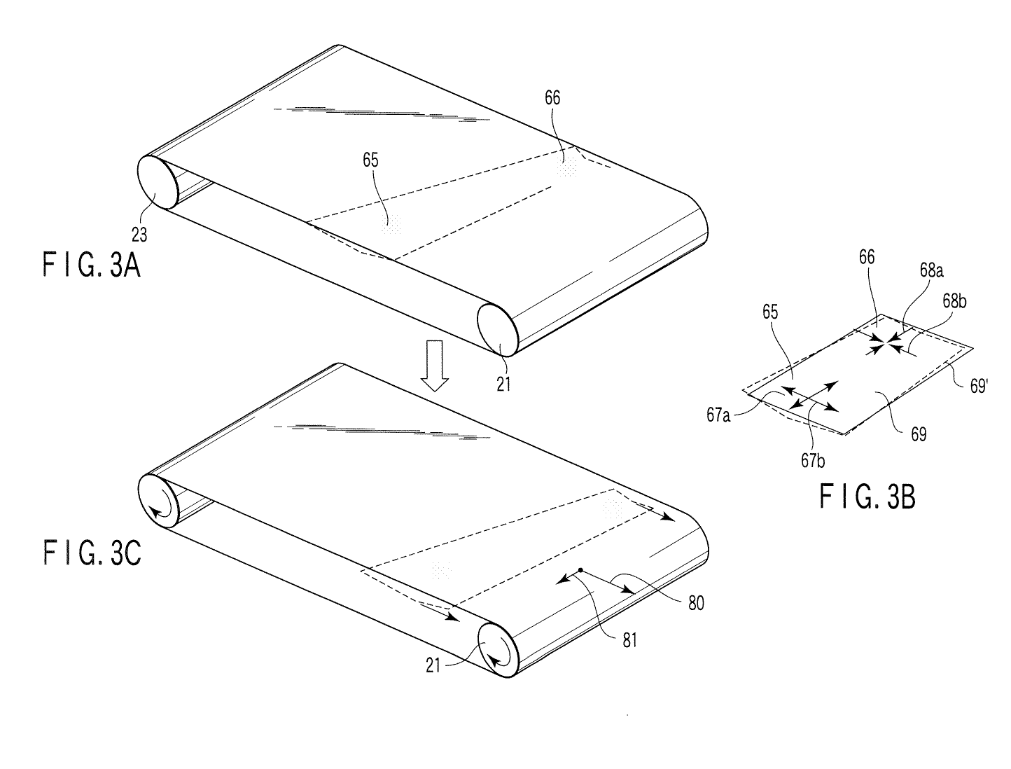

FIG. 3A to 3C show a principle on which any local deformation on the surface of the transfer belt member 2, when an image forming step has been repeated a predetermined number of times (over a predetermined time), that is, an adverse effect such as an elongation due to the application of heat, can be eliminated.

In order to maintain a transfer accuracy upon the formation of an image, a predetermined tension force is applied to the transfer belt member 2, for example, by the tension roller 21 (see FIG. 1) or guide rollers 17, 18.

When the transfer belt member 2 under a predetermined tension applied by the drive roller 23 and tension roller 21 as shown in FIG. 3A is locally heated or cooled in such a state that the driving by the roller is stopped, that is, the belt surface is not moved, then a temperature distribution is generated in the belt surface (belt member itself) and belt elongation or contraction proportional to the coefficient of linear expansion inherent in the belt material is generated as shown extracted in FIG. 3B. It is to be noted that FIG. 3A shows an example of heating an arbitrary position (a to be heated portion) 65 of the belt member and cooling an arbitrary position (a to be cooled portion) 66 of the belt member. At this time, as shown in FIG. 3B, the heating position 65 and its near portion of the belt member are expanded as indicated by arrows 67a, 67b and the cooling position 66 and its near portion of the belt member are contracted as indicated by arrows 68a, 68b. As a result, a corresponding cutout belt portion 69 is deformed to a generally sector-like configuration.

When the belt member 2 is driven in this state, as shown in FIG. 3C, the belt surface is moved in a conveying direction as indicated by an arrow 70 with the portion of the belt member 2 thermally deformed to the sector-like state. Thus, the belt surface is moved toward an axial direction of the rollers 21, 23. That is, the surface of the belt member 2 is moved in a sector-like deformed state compared with the state in which there is no temperature gradient in the belt surface. As a result, the belt member 2 is obliquely run or moved.

In other words, where the belt member 2 is obliquely run due to an elongation and contraction corresponding to the coefficient of linear expansion inherent in the belt material caused by the repetition of image forming steps, it is possible to control the amount of oblique movement of the belt member by locally heating or cooling the belt member, that is, by giving a temperature gradient to the belt member itself.

FIG. 4 shows one form of a heating unit utilizable to give a temperature gradient to the belt member itself as explained in connection with FIGS. 3A to 3C. That is, the heating unit as shown in FIG. 4 can locally expand the transfer belt member 2 by being incorporated into the image forming apparatus generally explained in FIG. 1.

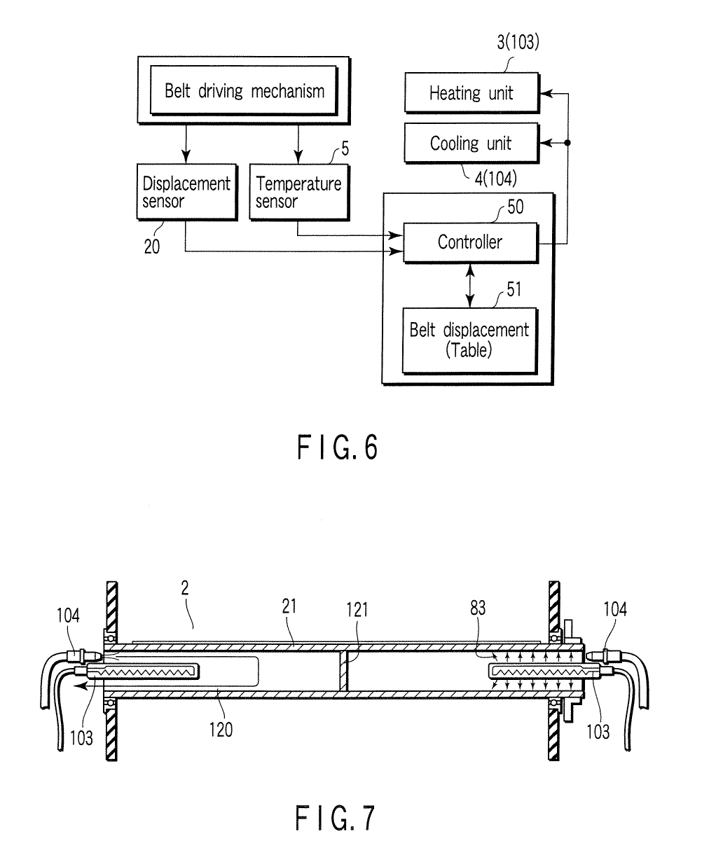

As shown in FIG. 4, the heating unit 3 is comprised of a matrix array of, for example, far-infrared heaters 81 capable of heating the belt member 2 for a brief time and has a structure capable of selectively operating any heaters by a control mechanism as explained later in connection with FIG. 6. Thus, the temperature of the belt member 2 can be locally, that is, partially, heated in a width direction of the belt member 2.

FIG. 5 shows one form of a cooling unit utilizable to give a temperature gradient to the belt member itself as explained in connection with FIGS. 3A to 3C. That is, the cooling unit as shown in FIG. 5 can locally contract the transfer belt member 2 by being incorporated into the image forming apparatus generally explained in connection with FIG. 1.

As shown in FIG. 5, the cooling unit 4 is comprised of a matrix array of valves (air nozzles) 91 capable of cooling the belt member 2 for a brief time period with air current (air) and turning any arbitrary valves on (that is, supplying the air to any arbitrary valves) by a control mechanism explained later in connection with FIG. 6. Thus, the belt member 2 can be cooled locally, or partially, in the width direction of the belt member 2.

Now an explanation will be made below about the method (belt oblique movement correction control) of controlling the oblique movement of the belt member 2, while continuing the formation of an image in the image forming apparatus 1 shown in FIG. 1.

The heating unit 3 and cooling unit 4 as explained in connection with FIGS. 4 and 5 are controlled by the control mechanism (see FIG. 6) as will be set out below. It is to be noted that the heating unit 3 and cooling unit 4 are given such a length as to cover the full width area of the transfer belt member 2, shown in FIG. 2, in a direction orthogonal to that in which the surface of the transfer belt member is moved by the drive roller 23. Preferably, the temperature sensing unit 5 includes two temperature sensors 5a and 5b located in a spaced-apart relation in a belt width direction, that is, in a direction orthogonal to that in which the surface of the belt member 2 is moved by the rotation of the drive roller 23 (see FIG. 1).

The oblique movement amount and temperature of the belt member 2 are detected, by the displacement sensor (belt edge sensing means) 20 and temperature sensing unit 5, relative to arbitrary positions on the belt surface moved by the drive roller 23 rotated by a motor 22.

Reference is made to a control amount table 51 defined based on the relation of the movement amount (belt oblique movement amount) and temperature of the transfer belt member 2 initially found by test runs, etc., in accordance with the belt oblique movement amount detected. It is to be noted that the operations of the heating unit 3 and cooling unit 4, that is, the on/off switching and the target temperature, are set by the control of a controller 50.

That is, the belt oblique movement toward the direction as indicated by an arrow 71 in FIG. 3C is matched to a higher temperature direction as viewed in a belt width direction when the temperature of the belt member 2 reaches a given level range or the elongation of the belt member 2 falls within a given amount range. In many cases, therefore, a higher temperature side cooling unit 4 portion as viewed in the width direction of the belt member 2 is turned on and a lower temperature side heating unit 3 portion as viewed in the width direction of the belt member 2 is turned on, meaning that the temperature gradient ceases to exist.

It is to be noted that the oblique movement (running) amount of the belt member 2 slightly differs dependent upon the mount error of the drive roller 23, tension roller 21 and guide rollers 17, 18, diameters of these rollers, variations of the belt full length, etc. For this reason, control amounts to be stored in the control amount table 51 are defined based on the above-mentioned test run.

It is confirmed that, in a special case where the elongation of the belt member 2 exceeds a given amount or the belt temperature exceeds a predetermined temperature, an opposite amount of belt oblique movement exists in a direction opposite to that in which the belt member 2 elongates. Therefore, the above-mentioned control amount table 51 is corrected in accordance with not only the temperature variation but also the direction in which the belt oblique movement is actually detected by the belt edge sensor 20.

With the use of the thus structured belt drive mechanism, the oblique movement of the belt member caused by the accuracy level of the belt formation and rotation shaft and/or the mount errors, etc., upon the assembly of a drive system can be positively corrected over a longer time while taking into consideration a cumulative total of image formation steps involved.

FIG. 7 shows another embodiment of a transfer belt oblique movement correction mechanism shown in FIG. 2.

The transfer belt oblique movement correction mechanism shown in FIG. 7 uses any arbitrary one (for example a tension roller 21) of those rollers configured to apply a predetermined tension force to the transfer belt member 2 while retaining the belt member 2, the tension roller 21 being hollow-cylindrical in configuration, and heating sources 103 and cooling sources 104 incorporated into the hollow-cylindrical roller 21 as an integral unit.

The heating sources 103 are comprised of, for example, a pair of halogen heaters, right and left, provided at predetermined places on the inner sides of two open end portions of the roller 21 and controllable individually, noting that, as the heating sources, use is made of at least two such heating sources.

The cooling sources 104 are comprised of, for example, a pair of air nozzles, right and left, provided at predetermined places on the inner sides of two open end portions of the roller 21 and controllable individually, noting that, as the cooling sources, use is made of at least two such cooling means.

A shielding partition wall 121 is provided at a generally middle position of a longitudinal area of the roller 21 to prevent air (cooling air) which is supplied from the one-end side cooling source 104 into the roller 21 from being blown through the other-end side of the roller 21 and cooling the heating source provided at that other side of the roller 21.

By incorporating the heating source and cooling source in the inner side of the tension roller 21, as one unit, which applies a predetermined tension force to the transfer belt member 2, the right and left belt width portions of the transfer belt member 2 which is run by the rotation of the drive roller 23 can be individually independently heated or cooled to provide a temperature gradient in the transfer belt width direction.

In this way, it is possible to control the amount of oblique movement of the belt member 2 which is produced due to the elongation or contraction corresponding to the coefficient of linear expansion inherent in the belt material caused by a repeated image formation steps involved.

The amount of the oblique movement of the transfer belt member caused by the accuracy level of the belt formation and rotation shaft and/or mount errors upon the assembly of a drive system can be freely corrected, taking into consideration a cumulative total of image formation steps involved.

It is to be noted that the above-mentioned heating sources and cooling sources may be incorporated into, for example, any of the drive roller 23 guide rollers 17, 18 instead of the tension roller 21.

When the belt surface of the endless belt member is moved at a predetermined speed by a roller unit, according to the present invention, the belt oblique-running extent, that is, the belt oblique movement amount, can be accurately set in a proper timing in a non-contact and non-impact relation to the belt edge as set out above. That is, by the heating and cooling mechanisms independently controllable relative to the width direction of the belt surface moved by the rotation of the rotation shaft, the transfer belt member is heated and/or cooled locally to correct the displacement of the transfer belt member in a direction orthogonal to that in which the belt surface is moved. Thus the belt member is prevented from making contact with the roller edge and roller retaining section and it is possible to obtain correct color registration. It is also possible to lengthen the service life of the belt member and reduce the apparatus cost involved.

The present invention is not restricted to the above-mentioned embodiments and various changes or modifications of the present invention can be made in any practical stages without departing from the essence of the present invention. Further, the individual forms of the embodiment may be properly combined together in any possible extent and it is possible to obtain an advantage or advantages through such a combination.

What is claimed is:

1. A belt member driving mechanism comprising:
a first roller having a rotation shaft and configured to be rotated in a first direction;
a belt member including a belt surface having a predetermined width in a second direction orthogonal to the first direction and configured to be rotated by a driving force from the first roller;
a second roller configured to apply a predetermined tension force to the belt member in cooperation with the first roller; and
a temperature control unit, including a detection unit which detects an elongation and/or a contraction of the belt surface of the belt member, configured to produce a temperature difference along the second direction of the belt surface of the belt member to reduce the elongation or contraction.

2. The driving mechanism according to claim 1, in which the temperature control unit includes a heating source provided on each of at least two places of the belt surface of the belt member along the second direction to allow different portions of the belt surface to be independently heated.

3. The driving mechanism according to claim 1, in which the temperature control unit includes a cooling mechanism provided on each of at least two places of the belt surface of the belt member along the second direction to allow different portions of the belt surface to be independently cooled.

4. The driving mechanism according to claim 1, in which the temperature control unit includes a heating source provided on each of at least two places of the belt surface of the belt member along the second direction to allow the belt surface to be independently heated and a cooling mechanism provided on each of at least of the belt surface of the belt member along the second direction to allow the belt surface to be independently cooled.

5. The drive mechanism according to claim 2, in which the heating source is comprised of a plurality of heater arrays provided in the second direction along the belt surface of the belt member.

6. The drive mechanism according to claim 3, in which the cooling mechanism is comprised of a plurality of cooling member arrays provided at the second direction along the belt surface of the belt member.

7. The drive mechanism according to claim 4, in which the heating source and cooling mechanism are each comprised of a plurality of heater arrays and cooling member arrays provided in the second direction along the belt surface of the belt member.

8. The drive mechanism according to claim 4, in which at least one of the first roller and second roller includes a cylindrical area and the heating source and cooling mechanism are mounted from each open end of the cylindrical area toward an inside as one unit.

9. The drive mechanism according to claim 8, in which the heating source and the cooling mechanism are so provided as to share the inside of the cylindrical area.

10. The driving mechanism according to claim 9, further comprising:
a shield structure is so provided in the cylindrical area as to prevent air which is supplied from the cooling mechanism on one open end side from cooling the heating source provided on the other open end side.

11. An image forming apparatus comprising:
a first roller having a rotation shaft and configured to be rotated in a first direction;
a belt-like photosensitive member including a belt surface having a predetermined width in a second direction orthogonal to the first direction and configured to be rotated by a drive force from the first roller;
a second roller configured to apply a predetermined tension force to the belt-like photosensitive member in cooperation with the first roller;
an image forming device arranged along a direction in which the belt surface of the belt-like photosensitive member is moved and configured to form any color toner image transferable to a transfer medium conveyed with the movement of the belt surface;
a heating mechanism configured to heat a predetermined position on the belt surface of the belt-like photosensitive member;
a cooling mechanism configured to cool a predetermined position on the belt surface of the belt-like photosensitive member; and
a temperature control unit configured to selectively operate the heating mechanism and cooling mechanism to create a temperature gradient on the belt surface along the second direction.

12. The image forming apparatus according to claim 11, further comprising:
a temperature sensor configured to defect temperature at a predetermined position of the belt surface in the second direction so as to be referred to by the temperature control unit; and
a displacement sensor configured to detect a positional displacement at the edge of the belt surface so as to be referred to by the temperature control unit.

13. A belt member driving method comprising:
detecting displacement of a belt surface of a belt member which is moved by the rotation of a drive roller driven about a rotation shaft;
detecting temperature at any position on the belt surface of the belt member; and
heating a predetermined position on the belt surface of the belt member, or cooling a predetermined position on the belt surface of the belt member, based on a detected displacement and temperature and controlling an amount of displacement on the belt surface of the belt member in and along a direction of the rotation shaft when the belt surface of the belt member is moved.
